(19) United States
(12) Patent Application Publication
(10) Pub. No.: US 2006/0074002 A1
(43) Pub. Date: Apr. 6, 2006

(54) Partially esterified copolymers of monoethylenically unsaturated dicarboxylic anthydrides, vinylaromatic compounds and other monoethylenically unsaturated monomers containing heteroatoms

(75) Inventors: Juergen Detering, Limburgerhof (DE); Tanja Schneider, Bensheim (DE); Matthias Kluglein, Ludwigshafen (DE); Pia Baum, Weinheim (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 10/541,663

(22) PCT Filed: Dec. 24, 2003
(86) PCT No.: PCT/EP03/14878

§ 371 Date: Jul. 8, 2005

(30) Foreign Application Priority Data
Jan. 13, 2003 (DE) 10301009.2

(51) Int. Cl. C11D 17/00

(52) U.S. Cl. 510/446; 510/475

(57) ABSTRACT

The invention relates to copolymers which can be obtained by radical polymerisation of (A) at least one monoethylenically unsaturated C4-C8 dicarboxylic acid anhydride, (B) at least one vinylaromatic compound from the group containing styrol and substituted styrols, and (C) at least one monoethylenically unsaturated monomer which contains at least one heteroatom and is different from (A); by partial esterification of the obtained copolymers with (D) alcohol alkoxylates of formula (I) wherein the variables have the following designations: R represents C2-C6 alkylene radicals which can be the same or different for n>1, R¹ represents C1-C30 alkyl, and n represents a number between 1 and 200; and as desired, by hydrolysis of the anhydride groups still contained in the copolymers in order to form carboxyl groups. The invention also relates to the use of said copolymers as additives for washing and cleaning products.

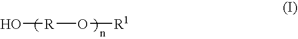

Partially esterified copolymers of monoethylenically unsaturated dicarboxylic anhydrides, vinylaromatic compounds and further monoethylenically unsaturated monomers containing heteroatoms

The present invention relates to copolymers which are obtainable by free-radical polymerization of
(A) at least one monoethylenically unsaturated C₄-C₈-dicarboxylic anhydride,
(B) at least one vinylaromatic compound from the group consisting of styrene and substituted styrenes and
(C) at least one monoethylenically unsaturated monomer which contains at least one heteroatom and is different from (A),
   and partial esterification of the resulting copolymers with
(D) alcohol alkoxylates of the formula I 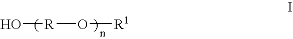
in which the variables have the following meanings:
R is C₂-C₆-alkylene radicals, which, when n is >1, may be identical or different;
R¹ is C₁-C₃₀-alkyl;
n is 1 to 200,
   and if desired hydrolysis of the anhydride groups still present in the copolymers to give carboxyl groups.

Furthermore, the invention relates to the use of these copolymers as additive for detergents and cleaners, in particular as graying-inhibiting and detergency-boosting additive in detergents, and also to solid and liquid detergents which comprise the copolymers as additive.

In the washing process, a distinction is drawn between primary and secondary detergency. Primary detergency is understood as meaning the actual removal of soiling from the textile ware. Secondary detergency is understood as meaning the prevention of the effects which arise as the result of redeposition of the detached soiling from the wash liquor onto the fabric. The textiles become increasingly gray from washing operation to washing operation and this insidious graying process can scarcely be reversed. In order to protect textiles made of cotton from becoming gray, sodium salts of carboxymethylcellulose (CMC) are often added to the detergent. Polyacrylic acids and acrylic acid-maleic acid copolymers also have a graying-inhibiting action. However, the action of said polymers is not satisfactory for clay-containing soiling.

EP-A-945 473 and 945 501 describe graft copolymers of styrene, maleic anhydride and polyethylene glycols which are used as soil repellent additive in cleaning formulations and detergents.

U.S. Pat. No. 3,485,762 discloses detergent compositions which comprise ammonium salts of a styrene-maleic anhydride copolymer partially esterified with a nonionic surfactant as detergency booster.

Styrene-maleic anhydride copolymers partially esterified with polyethylene glycols are also known from EP-A-306 449, according to which they can be used as cement liquefiers.

It is an object of the present invention to provide polymeric detergent additives which are characterized by overall advantageous application properties, in particular have improved primary and secondary detergency and can be readily and stably incorporated into solid and liquid detergent formulations.

We have found that this object is achieved by copolymers which are obtainable by free-radical polymerization of
(A) at least one monoethylenically unsaturated C₄-C₈-dicarboxylic anhydride,
(B) at least one vinylaromatic compound from the group consisting of styrene and substituted styrenes and
(C) at least one monoethylenically unsaturated monomer which contains at least one heteroatom and is different from (A),
   and partial esterification of the resulting copolymers with
(D) alcohol alkoxylates of the formula I 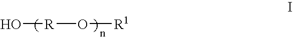
in which the variables have the following meanings:
R is C₂-C₆-alkylene radicals, which, when n is >1, may be identical or different;
R¹ is C₁-C₃₀-alkyl;
n is 1 to 200,
   and if desired hydrolysis of the anhydride groups still present in the copolymers to give carboxyl groups.

As a rule, the copolymers according to the invention have the following composition: the molar ratios of (B) to (A) and of (C) to (A) are in each case in the range from 0.1:1 to 10:1, where the molar ratio of [(B)+(C)] to (A) is 20:1 to 1:2.

In this connection, for the molar ratio of (B) to (A), a range from 0.2:1 to 5:1 is preferred, and from 0.3:1 to 3:1 is particularly preferred.

The molar ratio of (C) to (A) is preferably 0.1:1 to 5:1, in particular 0.1:1 to 3:1.

The molar ratio of [(B)+(C)] to (A) is preferably 10:1 to 1:1 and particularly preferably 6:1 to 1:1.

Used as monomer (A) for the preparation of the copolymers according to the invention are monoethylenically unsaturated dicarboxylic anhydrides having 4 to 8 carbon atoms. Examples which may be specifically mentioned are maleic anhydride, itaconic anhydride, citraconic anhydride and methylenemalonic anhydride. Preference is given here to itaconic anhydride and in particular maleic anhydride.

The vinylaromatic monomers (B) used are styrene and substituted styrenes, such as alkylstyrenes, in particular C₁-C₄-alkylstyrenes, e.g. methylstyrenes and ethylstyrenes, styrenesulfonic acids and salts thereof and halogenated styrenes, in particular chlorostyrenes, very particular preference being given to unsubstituted styrene.

Suitable as monomer (C) are a number of monoethylenically unsaturated compounds having at least one heteroatom. The heteroatoms, e.g. nitrogen or oxygen atom, can be incorporated into the carbon chain or be present in the form of a functional group, e.g. a carboxyl, ester, amide or cyano group.

Examples of particularly suitable monomers (C) which may be mentioned are:
monoethylenically unsaturated C₃-C₅-carboxylic acids, such as maleic acid, fumaric acid, crotonic acid and in particular acrylic acid and methacrylic acid;
C₁-C₂₂-alkyl esters of monoethylenically unsaturated C₃-C₅-carboxylic acids, in particular (meth)acrylic esters, such as methyl, ethyl, propyl, n-butyl, isobutyl, 2-ethylhexyl, decyl, lauryl, isobornyl, cetyl, palmityl and stearyl (meth)acrylate, basic esters of these carboxylic acids, in particular dialkylaminoalkyl (meth)acrylates, such as dimethylaminoethyl and diethylaminoethyl (meth)acrylate and dimethylaminopropyl and diethylaminopropyl (meth)acrylate, and salts thereof, and esters with methylpolyalkylene glycols, such as methylpolyethylene glycol (meth)acrylates with an average molecular weight Mₙ of from 200 to 5 000;
(meth)acrylamides, such as (meth)acrylamide, N-(C₁-C₁₂-alkyl)- and N,N-di(C₁-C₄-alkyl)(meth)acrylamides, such as N-methyl-, N,N-dimethyl-, N-ethyl-, N-propyl-, N-tert-butyl-, N-tert-octyl- and N-undecyl(meth)acrylamide, ethoxylation products thereof, such as methylpolyethylene glycol (meth)acrylamides with an average molecular weight Mₙ of from 200 to 5 000, and basic amides of these carboxylic acids, in particular N,N-(di-C₁-C₃-alkyl)amino-C₂-C₆-alkyl(meth)acrylamides, such as dimethylaminoethyl- and diethylaminoethyl(meth)acrylamide and dimethylaminopropyl- and diethylaminopropyl(meth)acrylamide;
vinyl esters of C₂-C₃₀-carboxylic acids, in particular C₂-C₁₄-carboxylic acids, such as vinyl acetate, vinyl propionate, vinyl butyrate, vinyl 2-ethylhexanoate and vinyl laurate;
vinyl C₁-C₃₀-alkyl ethers, in particular vinyl C₁-C₁₈-alkyl ethers, such as vinyl methyl ether, vinyl ethyl ether, vinyl n-propyl ether, vinyl isopropyl ether, vinyl n-butyl ether, vinyl isobutyl ether, vinyl 2-ethylhexyl ether and vinyl octadecyl ether;
N-vinylamides and N-vinyllactams, such as N-vinylformamide, N-vinyl-N-methylformamide, N-vinylacetamide, N-vinyl-N-methylacetamide, N-vinylpyrrolidone, N-vinylpiperidone and N-vinylcaprolactam;
allyl alcohol alkoxylates of the formula H—(O—R′)ₘ—O—CH₂—CH═CH₂ (R′: linear or branched C₂-C₇-alkylene, preferably ethylene or propylene; m: 1 to 500, preferably 2 to 300);
vinyl-substituted nitrogen heterocycles, such as 1-vinylimidazole, 2-methyl-1-vinyl-imidazole, N-vinyloxazolidone, N-vinyltriazole, 2-vinylpyridine, 4-vinylpyridine, 4-vinylpyridine N-oxide, N-vinylimidazoline and N-vinyl-2-methylimidazoline;
nitriles, such as acrylonitrile and methacrylonitrile.

Preferred monomers (C) are acrylic acid, methacrylic acid, (meth)acrylic esters and amides, in particular methyl acrylate, methyl methacrylate and acrylamide, vinyl alkyl ethers, in particular vinyl n-butyl ether and vinyl isobutyl ether, N-vinylamides, in particular N-vinylformamide and N-vinylpyrrolidone, and vinyl-substituted nitrogen heterocycles, in particular 1-vinylimidazole and 4-vinylpyridine.

The esterification component (D) used are alcohol alkoxylates of the formula I

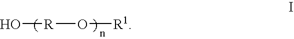

Here, R is linear or branched C₂-C₆-alkylene, preferably ethylene, propylene or butylene. The radicals R can, when n is >1, be identical or different. Different radicals R may be arranged blockwise or randomly.

R¹ is linear or branched C₁-C₃₀-alkyl.

Finally, n is 1 to 200, preferably 4 to 100, particularly preferably 4 to 50.

Examples of particularly suitable components (D) are:
polyethylene glycols of the formula I capped at one end with methyl end groups and in which n is 1 to 200, preferably 4 to 100 and particularly preferably 4 to 50;
block copolymers of ethylene oxide, propylene oxide and/or butylene oxide capped at one end with methyl end groups and having an average molecular weight Mₙ of from 300 to 5 000;
random copolymers of ethylene oxide, propylene oxide and/or butylene oxide capped at one end with methyl end groups and having a molecular weight Mₙ of from 300 to 5 000;
alkoxylated C₂-C₃₀-alcohols, in particular fatty alcohol alkoxylates, oxo alcohol alkoxylates or Guerbet alcohol alkoxylates, where the alkoxylation can be carried out with ethylene oxide, propylene oxide and/or butylene oxide, e.g.
   C₁₃C₁₅-oxo alcohol ethoxylates with 3 to 30 ethylene oxide units,
C₁₃-oxo alcohol ethoxylates with 3 to 30 ethylene oxide units,
C₁₂C₁₄-fatty alcohol ethoxylates with 3 to 30 ethylene oxide units,
C₁₀-oxo alcohol ethoxylates with 3 to 30 ethylene oxide units,
C₁₀-Guerbet alcohol ethoxylates with 3 to 30 ethylene oxide units,
C₉C₁₁-oxo alcohol alkoxylates with 2 to 20 ethylene oxide units, 2 to 20 propylene oxide units and/or 1 to 5 butylene oxide units,
C₁₃C₁₅-oxo alcohol alkoxylates with 2 to 20 ethylene oxide units, 2 to 20 propylene oxide units and/or 1 to 5 butylene oxide units,
C₄C₈-alcohol ethoxylates with 2 to 20 ethylene oxide units.

The copolymers according to the invention are partially esterified with the alcohol alkoxylates 1. In general, 5 to 80%, preferably 10 to 65%, particularly preferably 20 to 50%, of the carboxyl groups present are esterified.

Preferably, the copolymers according to the invention do not contain anhydride groups, i.e. unesterified anhydride groups are hydrolyzed to carboxyl groups. The hydrolysis can be carried out with water or in particular with aqueous bases, as a result of which the carboxyl groups are converted to the corresponding salts.

The K values of the copolymers according to the invention are usually 6 to 200, in particular 10 to 100 (measured in accordance with H. Fikentscher at 25° C. in water and a polymer concentration of 1% by weight).

The preparation of the copolymers according to the invention can take place by solution polymerization, suspension polymerization or solvent-free by bulk polymerization of the monomers (A), (B) and (C) and subsequent partial esterification with (D), and, if desired, hydrolysis.

Suitable solvents here are polar solvents which are inert toward the acid anhydrides (A), e.g. acetone, tetrahydrofuran or dioxane. Suitable precipitating agents are, for example, toluene, xylene or aliphatic hydrocarbons.

The polymerization generally takes place at temperatures of from 40 to 200° C., preferably 60 to 150° C., over the course of 0.5 to 12 h, preferably 1 to 8 h and particularly preferably 1 to 5 h.

The polymerization is triggered in all of the processes using polymerization initiators. Suitable polymerization initiators here are all compounds which decompose into free radicals, e.g. peroxides, hydroperoxides, redox initiators and azo compounds, such as di-tert-butyl peroxide, tert-butyl peroctoate, tert-butyl perpivalate, tert-butyl per-2-ethylhexanoate, tert-butyl permaleate, tert-butyl perisobutyrate, benzoyl peroxide, diacetyl peroxide, succinyl peroxide, p-chlorobenzoyl peroxide, dicyclohexyl peroxide dicarbonate, 2,2′-azobis(isobutyronitrile), 2,2′-azobis(2-methylpropionamidine) dihydrochloride and 2,2′-azobis(4-methoxy-2,4-dimethylvaleronitrile). In general, these initiators are used in amounts of from 0.1 to 20% by weight, preferably 0.2 to 15% by weight, based on the weight of the monomers (A), (B) and (C).

The esterification of the copolymers with the alcohol alkoxylate (D) can be carried out in inert solvents or swelling agents, such as acetone, methyl ketone, tetrahydrofuran, toluene, xylene or aliphatic hydrocarbons, or in bulk. The amount of (D) is chosen here such that only partial esterification of the copolymers arises. The esterification can be accelerated by adding catalysts, in particular acidic catalysts, such as sulfuric acid, methanesulfonic acid, p-toluenesulfonic acid, dodecylbenzenesulfonic acid, hydrochloric acid or acidic ion exchangers. Following the esterification, the solvents, where used, are removed from the reaction mixture. If required, the partially esterified copolymers obtained are dissolved in water with the addition of bases. As a result, anhydride groups which are still present are hydrolyzed and converted to carboxylate groups. Suitable bases are, for example, sodium hydroxide solution, potassium hydroxide solution, ammonia, amines and alkanolamines. The pH of the copolymer solutions obtained in this way is generally 3 to 10 and preferably 5 to 8.

It is particularly advantageous for the alcohol alkoxylate (D) itself to be used as solvent or diluent for the copolymerization of (A), (B) and (C). When the copolymerization is complete, the reaction with (D) can be started or completed by increasing the temperature and/or adding catalysts. The solvent removal required when using other solvents, e.g. by distillation, can be dispensed with here. In this procedure, graft products of the reactants may also arise in a small fraction.

It is also possible to firstly hydrolyze the copolymers containing anhydride groups so that all of the anhydride groups are present as carboxyl groups, and then to carry out the esterification with (D) in accordance with known methods. Preference is given, however, to the procedure described above.

In addition, the copolymers according to the invention are also obtainable by firstly reacting (A) and (D) to give monoethylenically unsaturated mono- or diesters and then copolymerizing these with (B) and (C), the reaction being carried out such that 5 to 80% of the carboxyl groups present in the copolymer according to the invention are in esterified form.

The copolymers according to the invention are advantageously suitable as additive for cleaners, in particular cleaners for hard surfaces, such as dishwashing and household cleaners, and detergents.

The copolymers according to the invention are characterized here in particular by the following advantageous application properties, which render them particularly suitable for use in detergents: they disperse particles of soiling in an excellent manner and thus prevent redeposition of the soiling onto the fabric during washing. They thus prevent graying of the textiles. In addition, they improve the primary detergency both of liquid and of solid detergents. This is true particularly for particulate soilings, but hydrophobic, oil- and grease-containing fabric soilings are also removed more easily. In addition, they can be incorporated into solid and liquid detergent formulations without problems. In this connection, it should be emphasized that stability and homogeneity of the liquid detergents are not impaired by the copolymers according to the invention. Undesired phase formations and precipitations are not observed even upon prolonged storage.

The invention accordingly also provides detergent formulations which comprise the copolymers according to the invention as additive. The copolymers according to the invention can be used here in the form of the free acids or in partially or completely neutralized form.

Solid detergent formulations according to the invention comprise, in particular, the following components:
(a) 0.05 to 20% by weight of at least one copolymer according to the invention,
(b) 0.5 to 40% by weight of at least one nonionic, anionic and/or cationic surfactant,
(c) 0.5 to 50% by weight of an inorganic builder,
(d) 0 to 10% by weight of an organic cobuilder and
(e) 0 to 60% by weight of other customary ingredients, such as extenders, enzymes, perfume, complexing agents, corrosion inhibitors, bleaches, bleach activators, bleach catalysts, color transfer inhibitors, further graying inhibitors, soil release polyesters, fiber and color protection additives, silicones, dyes, bactericides, dissolution improvers and/or disintegrants,
   where the sum of components (a) to (e) is 100% by weight.

The solid detergent formulations according to the invention may be in the form of powders, granules, extrudates or tablets.

Liquid detergent formulations according to the invention preferably have the following composition:
(a) 0.05 to 20% by weight of at least one copolymer according to the invention,
(b) 0.5 to 40% by weight of at least one nonionic, anionic and/or cationic surfactant,
(c) 0 to 20% by weight of an inorganic builder,
(d) 0 to 10% by weight of an organic cobuilder,
(e) 0 to 60% by weight of other customary ingredients, such as sodium carbonate, enzymes, perfume, complexing agents, corrosion inhibitors, bleaches, bleach activators, bleach catalysts, color transfer inhibitors, further graying inhibitors, soil release polyesters, fiber and color protection additives, silicones, dyes, bactericides, organic solvents, solubility promoters, hydrotropes, thickeners and/or alkanolamines and
(f) 0 to 99.45% by weight of water.

Suitable nonionic surfactants (b) are in particular:
alkoxylated C₈-C₂₂-alcohols, such as fatty alcohol alkoxylates, oxo alcohol alkoxylates and Guerbet alcohol ethoxylates: the alkoxylation can be carried out with ethylene oxide, propylene oxide and/or butylene oxide. Block copolymers or random copolymers may be present. Per mole of alcohol, they usually comprise 2 to 50 mol, preferably 3 to 20 mol, of at least one alkylene oxide. A preferred alkylene oxide is ethylene oxide. The alcohols preferably have 10 to 18 carbon atoms.
Alkylphenol alkoxylates, in particular alkylphenol ethoxylates, which comprise C₆-C₁₄-alkyl chains and 5 to 30 mol of alkylene oxide/mole.
Alkyl polyglucosides which comprise C₈-C₂₂-, preferably C₁₀-C₁₈-alkyl chains and usually 1 to 20, preferably 1.1 to 5, glucoside units.
N-Alkylglucamides, fatty acid amide alkoxylates, fatty acid alkanolamide alkoxylates, and block copolymers of ethylene oxide, propylene oxide and/or butylene oxide.

Suitable anionic surfactants are, for example:
sulfates of (fatty) alcohols having 8 to 22, preferably 10 to 18, carbon atoms, in particular C₉C₁₁-alcohol sulfates, C₁₂C₁₄-alcohol sulfates, C₁₂-C₁₈-alcohol sulfates, lauryl sulfate, cetyl sulfate, myristyl sulfate, palmityl sulfate, stearyl sulfate and tallow fatty alcohol sulfate.
Sulfated alkoxylated C₈-C₂₂-alcohols (alkyl ether sulfates): compounds of this type are prepared, for example, by firstly alkoxylating a C₈-C₂₂-, preferably a C₁₀-C₁₈-, alcohol, e.g. a fatty alcohol, and then sulfating the alkoxylation product. For the alkoxylation, preference is given to using ethylene oxide.
Linear C₈-C₂₀-alkylbenzenesulfonates (LAS), preferably linear C₉-C₁₃-alkylbenzenesulfonates and -alkyltoluenesulfonates.
Alkanesulfonates, in particular C₈-C₂₄-, preferably C₁₀-C₁₈-, alkanesulfonates.
Soaps, such as the Na and K salts of C₈-C₂₄-carboxylic acids.

The anionic surfactants are added to the detergent preferably in the form of salts. Suitable cations in this connection are, for example, alkali metal ions, such as sodium, potassium and lithium, and ammonium salts, such as hydroxyethylammonium, di(hydroxyethyl)ammonium and tri(hydroxyethyl)ammonium salts.

Particularly suitable cationic surfactants which may be mentioned are:
C₇-C₂₅-alkylamines;
N,N-dimethyl-N-(hydroxy-C₇-C₂₅-alkyl)ammonium salts;
mono- and di(C₇-C₂₅-alkyl)dimethylammonium compounds quaternized with alkylating agents;
ester quats, in particular quaternary esterified mono-, di- and trialkanolamines esterified with C₈-C₂₂-carboxylic acids;
imidazoline quats, in particular 1-alkylimidazolinium salts of the formulae II or III 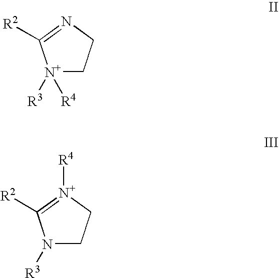
in which the variables have the following meanings:
R² is C₁-C₂₅-alkyl or C₂-C₂₅-alkenyl;
R³ is C₁-C₄-alkyl or hydroxy-C₁-C₄-alkyl;
R⁴ is C₁-C₄-alkyl, hydroxy-C₁-C₄-alkyl or a radical R²—(CO)—X—(CH₂)ₚ—(X: —O— or —NH—;
   p: 2 or 3),
where at least one radical R² is C₇-C₂₂-alkyl.

Suitable inorganic builders are, in particular:
Crystalline and amorphous alumosilicates with ion-exchanging properties, such as, in particular, zeolites: different types of zeolites are suitable, in particular the zeolites A, X, B, P, MAP and HS in their Na form or in forms in which Na is partially exchanged for other cations such as Li, K, Ca, Mg or ammonium.
Crystalline silicates, such as, in particular, disilicates and phyllosilicates, e.g. δ- and β-Na₂Si₂O₅. The silicates can be used in the form of their alkali metal, alkaline earth metal or ammonium salts, preference being given to the Na, Li and Mg silicates.
Amorphous silicates, such as sodium metasilicate and amorphous disilicate.
Carbonates and hydrogencarbonates: these can be used in the form of their alkali metal, alkaline earth metal or ammonium salts. Preference is given to Na, Li and Mg carbonates and hydrogencarbonates, in particular sodium carbonate and/or sodium hydrogencarbonate.
Polyphosphates, such as pentasodium triphosphate.

Suitable organic cobuilders are, in particular:
Low molecular weight carboxylic acids, such as citric acid, hydrophobically modified citric acid, e.g. agaric acid, malic acid, tartaric acid, gluconic acid, glutaric acid, succinic acid, imidodisuccinic acid, oxydisuccinic acid, propanetricarboxylic acid, butanetetracarboxylic acid, cyclopentanetetracarboxylic acid, alkyl- and alkenylsuccinic acids and aminopolycarboxylic acids, e.g. nitrilotriacetic acid, β-alaninediacetic acid, ethylenediaminetetraacetic acid, serinediacetic acid, isoserinediacetic acid, N-(2-hydroxyethyl)iminodiacetic acid, ethylenediaminedisuccinic acid and methyl- and ethylglycinediacetic acid.
Oligomeric and polymeric carboxylic acids, such as homopolymers of acrylic acid and aspartic acid, oligomaleic acids, copolymers of maleic acid with acrylic acid, methacrylic acid or C₂-C₂₂-olefins, e.g. isobutene or long-chain α-olefins, vinyl C₁-C₈-alkyl ethers, vinyl acetate, vinyl propionate, (meth)acrylic esters of C₁-C₈-alcohols and styrene. Preference is given to the homopolymers of acrylic acid and copolymers of acrylic acid with maleic acid. The oligomeric and polymeric carboxylic acids are used in acid form or as the sodium salt.

Suitable bleaches are, for example, adducts of hydrogen peroxide onto inorganic salts, such as sodium perborate monohydrate, sodium perborate tetrahydrate and sodium carbonate perhydrate, and percarboxylic acids, such as phthalimidopercaproic acid.

Suitable bleach activators are, for example, N,N,N′,N′-tetraacetylethylenediamine (TAED), sodium p-nonanoyloxybenzenesulfonate and N-methylmorpholinium acetonitrile methylsulfate.

Enzymes preferably used in detergents are proteases, lipases, amylases, cellulases, oxidases and peroxidases.

Suitable color transfer inhibitors are, for example, homopolymers, copolymers and graft polymers of 1-vinylpyrrolidone, 1-vinylimidazole and 4-vinylpyridine N-oxide. Homopolymers and copolymers of 4-vinylpyridine reacted with chloroacetic acid are also suitable as color transfer inhibitors.

Detergent ingredients are otherwise generally known. Detailed descriptions are given, for example, in WO-A-99/06524 and 99/04313; in Liquid Detergents, editor: Kuo-Yann Lai, Surfactant Sci. Ser., Vol. 67, Marcel Decker, New York, 1997, pp. 272-304.

### EXAMPLES

I. Preparation of Copolymers According to the Invention

Copolymers 1 to 9

108 g (1.10 mol) of maleic anhydride (A1) were dissolved in x₁ g (x₂ mol) of the alcohol alkoxylate (D) and heated to 90° C. under nitrogen and with stirring. At this temperature, 6 g of tert-butyl peroctoate, dissolved in a small partial amount of the alcohol alkoxylate (D), and a solution of y₁ g (y₂ mol) of the monomer (C) in z₁ g (z₂ mol) of styrene were slowly added dropwise over 2 h.

The resulting reaction mixture was then stirred for 4 h at 150° C. The resulting oil was taken up in 500 g of water, and the solution was adjusted to pH 6-7 with sodium hydroxide solution.

30 to 45% strength by weight low-viscosity polymer solutions were obtained. The K values of the copolymers prepared were determined in accordance with H. Fikentscher, Cellulose-Chemie, volume 13, 58-64 and 761-774 (1932) in aqueous solution at 25° C. and a polymer concentration of 1% by weight. Further details relating to these experiments and also the results thereof are summarized in table 1.

The alcohol alkoxylates (D) used were:

D1: methylpolyethylene glycol with an average molecular weight Mₙ of 500

D2: methylpolyethylene glycol with an average molecular weight Mₙ of 1 000

D3: ethoxylated C₁₃C₁₅-oxo alcohol (7 mol of EO/mol)

TABLE 1

| Copol- | x₁ g | | y₁ g | | z₁ g | K |
|---|---|---|---|---|---|---|
| ymer | (x₂ mol) | D | (y₂ mol) | Monomer C | (z₂ mol) | value |
| 1 | 550 (1.10) | D1 | 12 (0.14) | acrylic acid | 100 (0.96) | 36 |
| 2 | 550 (1.10) | D1 | 11 (0.11) | n-butyl vinyl ether | 102 (1.00) | 13 |
| 3 | 550 (1.10) | D1 | 50 (0.12) | allyl alcohol ethoxylate | 102 (1.00) | 20 |
| | | | | (10 mol of EO/mol) | | |
| 4 | 550 (1.10) | D1 | 28 (0.28) | methyl methacrylate | 86 (0.84) | 25 |
| 5 | 550 (1.10) | D1 | 12 (0.11) | N-vinylpyrrolidone | 102 (1.00) | 43 |
| 6 | 550 (0.55) | D2 | 16 (0.22) | acrylic acid | 92 (0.90) | 51 |
| 7 | 560 (1.10) | D3 | 16 (0.22) | acrylic acid | 92 (0.90) | 48 |
| 8 | 550 (1.10) | D1 | 79 (1.10) | acrylic acid | 115 (1.12) | 51 |
| 9 | 1100 (1.10) | D2 | 159 (2.20) | acrylic acid | 229 (2.20) | 43 |

Copolymers 10 to 14

a) reparation of the precursors

a1) Precursor PC1 for copolymers 10 to 12:

194 g (2.11 mol) of maleic anhydride (A1) and 20 g of polyethyl vinyl ether (K value 50, 1% strength by weight in cyclohexane at 25° C. in accordance with H. Fikentscher) were dissolved in 900 g of xylene and heated to 140° C. under nitrogen and with stirring. At this temperature, a mixture of 220 g (2.16 mol) of styrene and 158 g (2.20 mol) of acrylic acid, and a solution of 4 g of di-tert-butyl peroxide in 36 g of xylene were added in parallel over the course of 4 h.

After after-stirring for one hour at 140° C. and cooling to 50° C., the solvent was removed under reduced pressure.

The K value of the polymer present in the form of a white powder was 15.9 (1% strength by weight in cyclohexanone at 25° C.).

a2) Precursor PC2 for copolymers 13 and 14:

228 g (2.32 mol) of maleic anhydride (A1) and 20 9 of polyethyl vinyl ether (K value 50, 1% strength by weight in cyclohexane at 25° C. in accordance with H. Fikentscher) were dissolved in 1 100 g of xylene and heated to 140° C. under nitrogen and with stirring. At this temperature, a mixture of 230 g (2.25 mol) of styrene and 1 300 g (18.06 mol) of acrylic acid, and a solution of 12 g of di-tert-butyl peroxide in 140 g of xylene were added in parallel over 4 h.

After after-stirring for one hour at 140° C. and cooling to 50° C., the solvent was removed under reduced pressure.

The K value of the polymer present in the form of a white powder was 24.2 (1% strength by weight in cyclohexanone at 25° C.).

b) Conversion of the Precursors to the Copolymers

To prepare the copolymers 10 to 14, in each case a mixture of the precursors PCl and PC2 and x mol of the alcohol alkoxylate (D) per mole of maleic anhydride were heated to 170° C. under nitrogen and with stirring.

After stirring for four hours at 170° C. and cooling to 50° C., the resulting oil was dispersed with sodium hydroxide solution. The molar ratio of sodium hydroxide solution to (maleic anhydride+acrylic acid) was 0.6:1.0, giving 30 to 40% strength by weight dispersions of the copolymers with a pH of from 6 to 7.

Further details relating to these experiments and the results thereof are summarized in table 2.

The alcohol alkoxylates (D) used were:
D2: methylpolyethylene glycol with an average molecular weight Mₙ of 1 000
D3: ethoxylated C₁₃C₁₅-oxo alcohol (7 mol of EO/mol)
D4: random butylpolyalkylene glycol copolymer (EO:PO in the weight ratio 1:1) with an average molecular weight Mₙ of 1 000
D5: C₁₃C₁₅-oxo alcohol (5 mol of PO/mol, 5 mol of EO/mol)

D6: C₁₃C₁₅-oxo alcohol (12 mol of EO/mol, 3 mol of PO/mol)

TABLE 2

| | | x mol/mol | Alcohol | |
|---|---|---|---|---|
| Copolymer | Precursor | of MAA | alkoxylate | K value |
| 10 | PC1 | 0.75 | D4 | 32 |
| 11 | PC1 | 0.75 | D5 | 35 |
| 12 | PC1 | 1.0 | D3 | 29 |
| 13 | PC2 | 1.0 | D2 | 43 |
| 14 | PC2 | 1.0 | D6 | 36 |

II. Use of Copolymers According to the Invention in Detergents

Primary and secondary detergency of the copolymers according to the invention was determined.

For the washing experiments, three solid detergent formulations (DT 1 to 3) and 2 f copolymers according to the invention in detergents liquid detergent formulations (DT 4 and 5) were used, the composition of which is given in table 3. The washing conditions are listed in table 4.

TABLE 3

| | DT 1 | DT 2 | DT 3 | DT 4 | DT 5 |
|---|---|---|---|---|---|
| | [% by | [% by | [% by | [% by | [% by |
| Ingredients | wt.] | wt.] | wt.] | wt.] | wt.] |
| Linear alkylbenzene- | 5.0 | 0.8 | 7.0 | | |
| sulfonate | | | | | |
| C₁₂-C₁₈-alkyl | | 12.0 | | 26.7 | 6.1 |
| sulfate | | | | | |
| C₁₂-fatty | | | | 7.1 | |
| alcohol sulfate × 2 EO | | | | | |
| C₁₃C₁₅-oxo | 5.0 | 4.7 | 7.0 | | |
| alcohol × 7 EO | | | | | |
| C₁₂C₁₄-fatty | | | | 6.0 | 26.0 |
| alcohol × 7 EO | | | | | |
| Soap | 1.4 | 0.4 | 0.8 | | |
| Coconut fatty acid | | | | 5.0 | 14.3 |
| Potassium hydroxide | | | | 1.4 | 5.4 |
| Sodium citrate × | | 5.0 | 10.0 | 2.1 | 4.1 |
| 2H₂O | | | | | |
| Zeolite A | 30.0 | 15.0 | | | |
| Phyllosilicate SKS 6 | | 14.0 | | | |
| Sodium carbonate | 12.0 | | 20.0 | | 1.4 |
| Sodium hydrogen- | | 9.0 | | | |
| carbonate | | | | | |
| Sodium metasilicate × | 3.6 | | | | |
| 5H₂O | | | | | |
| Sodium disilicate | | | 5.0 | | |
| Disodium tetraborate | | | | 2.2 | |
| Sodium perborate | 20.0 | | | | |
| monohydrate | | | | | |
| Sodium percarbonate | | 18.0 | 15.0 | | |
| Tetraacetylethylene- | 6.0 | 4.5 | 4.0 | | |
| diamine | | | | | |
| Methylpropyl glycol | | | | 10 | |
| Ethanol | | | | | 2 |
| Sodium sulfate | 7.0 | 3.2 | 25.0 | | |
| Magnesium silicate | | 0.8 | | | |
| Water | ad 100 | ad 100 | ad 100 | ad 100 | ad 100 |

TABLE 4
Washing conditions

| | |
|---|---|
| Device | Launder-o-meter from Atlas, Chicago, USA |
| Washing liquor | 250 ml |
| Washing time | 30 min at 40° C. |
| Detergent | 4.5 g/l |
| concentration | |
| Water hardness | 3 mmol/l Ca:Mg:HCO₃ 4:1:8 |
| Liquor ratio | 1:12.5 |
| Washing cycles | 1 |
| Copolymer | 2.5% by weight, based on the respective DT |
| addition | |
| Test fabric | 5.0 g of cotton fabric 221 (bleached, weight per unit area |
| | 132 g/m²) |
| | 5.0 g of blended fabric 768 (65:35 polyester:cotton, |
| | bleached, weight per unit area 155 g/m²) |
| Soiled fabric | 10 g of cotton fabric 290 (twill ware, bleached, weight |
| | per unit area 193 g/m²), |
| | soiled with a 1:1:1 mixture of 3 types of clay |
| | (Na/Al silicate proportion of the soiled fabric 4.53% by |
| | weight) |
| Types of clay | Niederahr red-burning clay 178/RI |
| | Hessian brown-burning manganese clay 262 |
| | Yellow-burning clay 158/G |
| | all from Jäger KG, Hilgert, Germany |

To determine the primary detergency, the degree of whiteness of the soiled fabric was measured before and after washing using a Datacolor photometer (Elrepho® 2000) by reference to the reflectance (%). The higher the reflectance value, the better the primary detergency.

The results obtained are summarized in table 5.

TABLE 5

| | Copolymer additive | Cotton 290 |
|---|---|---|
| Detergent | (2.5% by weight) | Reflectance in % |
| unwashed | | 16.3 |
| DT 1 | without | 21.9 |
| DT 1 | Copolymer 4 | 24.4 |
| DT 1 | Copolymer 7 | 23.8 |
| DT 1 | Copolymer 12 | 25.0 |
| DT 2 | without | 22.0 |
| DT 2 | Copolymer 2 | 24.0 |
| DT 2 | Copolymer 5 | 24.9 |
| DT 4 | without | 21.2 |
| DT 4 | Copolymer 1 | 23.0 |
| DT 4 | Copolymer 4 | 23.5 |
| DT 4 | Copolymer 7 | 22.9 |
| DT 5 | without | 21.3 |
| DT 5 | Copolymer 2 | 22.8 |
| DT 5 | Copolymer 4 | 23.3 |
| DT 5 | Copolymer 14 | 23.9 |

To determine the secondary detergency, the graying of the white test fabric was measured by determining the degree of whiteness before and after washing using a Datacolor photometer (Elrepho® 2000) by reference to the reflectance (%). The greater the drop in the degree of whiteness, the greater the graying of the fabric, and vice versa.

The results obtained are summarized in table 6.

TABLE 6

| | | | Blended fabric |
|---|---|---|---|
| | Copolymer additive | Cotton 221 | 768 |
| Detergent | (2.5% by wt.) | Reflectance in % | Reflectance in % |
| unwashed | | 83.2 | 84.9 |
| DT 1 | without | 55.2 | 55.4 |
| DT 1 | Copolymer 1 | 59.9 | 60.5 |
| DT 1 | Copolymer 4 | 61.0 | 61.9 |
| DT 1 | Copolymer 5 | 60.9 | 61.1 |
| DT 1 | Copolymer 6 | 59.2 | 61.0 |
| DT 1 | Copolymer 8 | 63.1 | 61.8 |
| DT 1 | Copolymer 9 | 62.4 | 61.2 |
| DT 1 | Copolymer 12 | 60.8 | 61.2 |
| DT 2 | without | 54.3 | 55.5 |
| DT 2 | Copolymer 1 | 60.5 | 60.6 |
| DT 2 | Copolymer 2 | 60.1 | 59.7 |
| DT 2 | Copolymer 3 | 59.6 | 61.1 |
| DT 2 | Copolymer 10 | 60.7 | 60.2 |
| DT 2 | Copolymer 11 | 59.3 | 58.5 |
| DT 3 | without | 51.4 | 52.1 |
| DT 3 | Copolymer 1 | 55.5 | 54.2 |
| DT 3 | Copolymer 8 | 57.5 | 58.1 |
| DT 3 | Copolymer 13 | 56.9 | 56.5 |
| DT 4 | without | 48.4 | 54.8 |
| DT 4 | Copolymer 1 | 59.5 | 60.6 |
| DT 4 | Copolymer 4 | 56.6 | 59.3 |
| DT 4 | Copolymer 5 | 58.0 | 60.1 |
| DT 4 | Copolymer 6 | 60.3 | 58.9 |
| DT 4 | Copolymer 8 | 57.4 | 57.4 |
| DT 4 | Copolymer 9 | 58.4 | 56.9 |
| DT 5 | without | 53.4 | 46.7 |
| DT 5 | Copolymer 2 | 59.5 | 54.9 |
| Detergent | Copolymer as additive | Cotton 221 | Blended fabric |
| | (2.5% by wt.) | | 768 |
| DT 5 | Copolymer 4 | 59.2 | 58.0 |
| DT 5 | Copolymer 5 | 29.3 | 55.3 |

To ascertain the stability of the copolymers in various liquid detergent formulations, in each case 1% by weight of copolymer was formulated into the liquid detergent, and a visual assessment with regard to phase separation, clouding, incompatibilities, etc. was undertaken.

The stability tests were carried out with liquid detergent formulations DT 4 and 5.

Table 7 summarizes the visual assessments after storage for 4 weeks at 40° C.

TABLE 7

| Copolymer | DT 4 | DT 5 |
|---|---|---|
| without | clear | clear |
| Copolymer 2 | clear | clear |
| Copolymer 3 | clear | clear |
| Copolymer 4 | streaks | clear |
| Copolymer 5 | clear | clear |
| Copolymer 8 | clear | clear |
| Copolymer 9 | clear | clear |
| Copolymer 13 | clear | clear |

1: A copolymer obtained by free-radical polymerization comprising polymerizing:
(A) at least one monoethylenically unsaturated C₄-C₈-dicarboxylic anhydride,
(B) at least one vinylaromatic compound from the group consisting of styrene and substituted styrenes and
(C) at least one monoethylenically unsaturated monomer which contains at least one heteroatom and is different from (A),
and partial esterification of the resulting copolymer with
(D) alcohol alkoxylates of the formula I 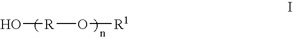
in which the variables have the following meanings:
R is C₂-C₆-alkylene radicals, which, when n is >1, may be identical or different;
R¹ is C₁-C₃₀-alkyl;
n is 1 to 200,
and optionally hydrolysis of the anhydride groups still present in the copolymer to give carboxyl groups.

2: The copolymer as claimed in claim 1, wherein the molar ratios of (B) to (A) and of (C) to (A) are each in the range from 0.1:1 to 10:1 and the molar ratio of [(B)+(C)] to (A) is 20:1 to 1:2.

3: The copolymer as claimed in claim 1, wherein 5 to 80% of the carboxyl groups present are esterified.

4: The copolymer as claimed in claim 1, wherein the anhydride groups still present are hydrolyzed to carboxyl groups.

5: The copolymer as claimed in claim 1, comprising maleic anhydride as monomer (A).

6: The copolymer as claimed in claim 1, comprising styrene as monomer (B).

7: The copolymer as claimed in claim 1, comprising (meth)acrylic acid, (meth)acrylic esters or amides, vinyl alkyl ethers, N-vinylformamide, N-vinylpyrrolidone, 1-vinylimidazole or 4-vinylpyridine as monomer (C).

8: An additive for detergents and cleaners comprising the copolymer as claimed in claim 1.

9: A graying-inhibiting additive in detergents comprising the copolymer as claimed in claim 1.

10: A detergency-boosting additive in detergents comprising the copolymer as claimed in claim 1.

11: A detergent formulation comprising the copolymer as claimed in claim 1.

12: A solid detergent formulation comprising
(a) 0.05 to 20% by weight of at least one copolymer as claimed in claim 1,
(b) 0.5 to 40% by weight of at least one nonionic, anionic and/or cationic surfactant,
(c) 0.5 to 50% by weight of an inorganic builder,
(d) 0 to 10% by weight of an organic cobuilder and
(e) 0 to 60% by weight of other customary ingredients, such as extenders, enzymes, perfume, complexing agents, corrosion inhibitors, bleaches, bleach activators, bleach catalysts, color transfer inhibitors, further graying inhibitors, soil release polyesters, fiber and color protection additives, silicones, dyes, bactericides, dissolution improvers and/or disintegrants,
where the sum of components (a) to (e) is 100% by weight.

13: A liquid detergent formulation comprising
(a) 0.05 to 20% by weight of at least one copolymer as claimed in claim 1,
(b) 0.5 to 40% by weight of at least one nonionic, anionic and/or cationic surfactant,
(c) 0 to 20% by weight of an inorganic builder,
(d) 0 to 10% by weight of an organic cobuilder,
(e) 0 to 60% by weight of other customary ingredients, such as sodium carbonate, enzymes, perfume, complexing agents, corrosion inhibitors, bleaches, bleach activators, bleach catalysts, color transfer inhibitors, further graying inhibitors, soil release polyesters, fiber and color protection additives, silicones, dyes, bactericides, organic solvents, solubility promoters, hydrotropes, thickeners and/or alkanolamines and
(f) 0 to 99.45% by weight of water.

14: A method for producing a detergent and cleaner comprising adding the copolymer as claimed in claim 1 to a detergent and cleaner formulation.

15: A method for inhibiting graying in detergent formulations comprising adding the copolymer as claimed in claim 1 to a detergent formulation.

16: A method for boosting the detergency in detergents comprising adding the copolymer as claimed in claim 1 to a detergent formulation.
